(19) United States
(12) Patent Application Publication
(10) Pub. No.: US 2004/0221169 A1
(43) Pub. Date: Nov. 4, 2004

(54) Computer-implemented method for controlling execution of application software by a computer terminal

(76) Inventors: Stephen J. Lee, Tai-Shan Hsiang (TW); Thomas P. Lee, Tai-Shan Hsiang (TW); Alin Lin, Tai-Shan Hsiang (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/765,280

(22) Filed: Jan. 28, 2004

(30) Foreign Application Priority Data
Jan. 30, 2003 (TW) 092102287

(51) Int. Cl. H04L 9/32

(52) U.S. Cl. 713/193

(57) ABSTRACT

Prior to execution of application software by a computer terminal, the computer terminal is connected to an electronic key and initiates a registration procedure with a remote server so as to obtain a software registration code that is stored in each of the computer terminal and the electronic key. Thereafter, it is only when the computer terminal is connected to the electronic key, and when the software registration code stored in the computer terminal matches that stored in the electronic key will subsequent execution of the application software by the computer terminal be enabled. The method as such can discourage software piracy.

### CROSS-REFERENCE TO RELATED APPLICATION

This application claims priority of Taiwanese application no. 092102287, filed on Jan. 30, 2003.

### BACKGROUND OF THE INVENTION

1. Field of the Invention

The present invention relates to the protection of intellectual property, more particularly to a computer-implemented method that can discourage software piracy.

2. Description of the Related Art

As a result of rapid promotion of replication techniques for electronic information and the steep price reduction in replication facilities for the same, almost no technical barrier exists at the moment for electronic information replication. As such, illegal copying of electronic information prevails, thereby inflicting software vendors with huge revenue losses due to software piracy. Therefore, many software vendors continuously strive to develop software anti-piracy methods to protect their intellectual property.

A popular conventional software anti-piracy method is implemented through the use of a software serial code and a password, which are unique to a particular software product. In this manner, successful installation of the software product is feasible only when the correct software serial code and password are inputted. However, infringers are able to find ways to bypass the input of software serial codes and passwords, and to make illegal copies of the software product that work with the same set of software serial code and password. Hence, use of software serial codes and passwords is insufficient for software anti-piracy.

In another conventional software anti-piracy method, some software vendors request consumers to initiate an on-line registration procedure so as to be able to monitor the use of the same set of software serial codes and passwords. However, the registration procedure is an optional procedure normally bypassed by users of pirated software.

In yet another conventional software anti-piracy method, when installing application software in a computer terminal, a portion of the application software recorded in an optical disc is not installed in the computer terminal. Hence, subsequent execution of the application software by the computer terminal requires loading of the optical disc on an optical disc drive for access to the non-installed portion of the application software. In this manner, a software product can only be executed using a single computer terminal at any time. However, since the entire contents of the optical disc can be illegally replicated on an unlimited number of recording media, intellectual property protection is still inadequate.

### SUMMARY OF THE INVENTION

Therefore, the object of the present invention is to provide a computer-implemented method for controlling execution of application software by a computer terminal so as to overcome the aforesaid drawbacks associated with the prior art.

According to the present invention, there is provided a computer-implemented method for controlling execution of application software by a computer terminal. At least a first portion of the application software is loaded into a data storage medium of the computer terminal. The method comprises:

a) when it is intended to execute the application software, enabling the computer terminal to detect presence of an electronic key that is connected thereto;

b) inhibiting execution of the application software upon detection by the computer terminal that the electronic key is disconnected therefrom;

c) upon detection by the computer terminal that the electronic key is connected thereto, enabling the computer terminal to verify presence of a software registration code in each of the computer terminal and the electronic key;

d) upon detection by the computer terminal that at least one of the computer terminal and the electronic key does not have a software registration code stored therein, enabling the computer terminal to initiate a registration procedure with a remote server so as to obtain the software registration code therefrom and so as to store the software registration code obtained from the remote server in each of the computer terminal and the electronic key;

e) upon detection by the computer terminal that each of the computer terminal and the electronic key has a software registration code stored therein, enabling the computer terminal to verify if the software registration code stored in the computer terminal matches that stored in the electronic key;

f) enabling further execution of the application software by the computer terminal upon detection thereby that the software registration code stored in the computer terminal matches that stored in the electronic key; and

g) aborting further execution of the application software by the computer terminal upon detection thereby that the software registration code stored in the computer terminal does not match that stored in the electronic key.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a system for implementing the preferred embodiment of a method for controlling execution of application software by a computer terminal according to the present invention; and

FIGS. 2 and 3 are flowcharts to illustrate steps of the method of the preferred embodiment.

### DETAILED DESCRIPTION OF THE PREFERRED EMBODIMENT

Conventional software anti-piracy methods are deficient in terms of forcing consumers to register purchased software products, and lack mechanisms to inhibit use of pirated software. To solve the aforesaid drawbacks of the prior art, a software product according to this invention includes application and registration software that are resident in at least two separate data storage media so as to increase difficulty in illegal software duplication. Moreover, one of the data storage media is preferably an intelligent data storage medium that can cooperate with a computer terminal so that unlicensed software cannot be executed by the computer terminal. Furthermore, to enforce software registration, a portion of the application software is preferably stored in a remote server managed by the software vendor and can be downloaded by the computer terminal only when registration is successful.

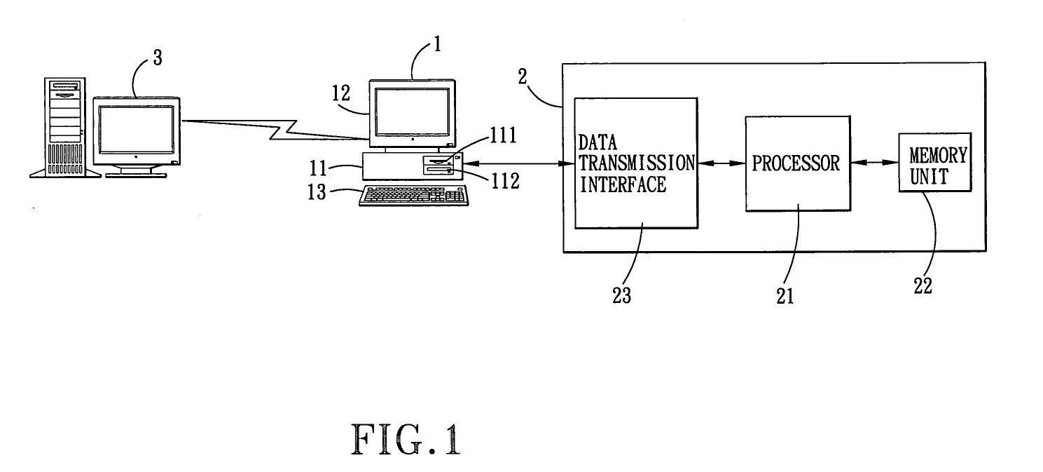

Referring to FIG. 1, a system for implementing the preferred embodiment of a method according to the present invention is shown to include a computer terminal 1, an electronic key 2, and a remote server 3.

The computer terminal 1 is a general computer, such as a desktop computer, a notebook computer, etc., and includes a host 11, a monitor 12, and a user input device 13, such as a keyboard. The host 11 includes a computer readable storage medium, such as a hard disk (not shown), a floppy disk drive 111, an optical disc drive 112, and a transmission interface adapted for coupling the host 11 to an external device, such as a Universal Serial Bus (USB) port, a Bluetooth transmission port, an infrared signal transmission port, a serial port, a parallel port, etc.

In the present invention, to facilitate management and tracking of software use, application software sold by a software vendor is associated with a distinct software serial code. In the preferred embodiment, a first portion of the application software is stored in a data storage medium, such as an optical disc or a floppy disk, to form a part of a software product according to this invention. The electronic key 2 constitutes the other part of the software product. A second portion of the application software is stored in the remote server 3 that is managed by the software vendor. Optionally, a third portion of the application software resides in the electronic key 2. The registration software that accompanies the application software in accordance with this invention resides in either the data storage medium or the electronic key 2, more preferably in the electronic key 2. The registration software preferably includes program instructions necessary for executing various routines, such as mathematical computations, string manipulations, encryption and decryption algorithms, database management, data transmission, etc. In the preferred embodiment, for convenience in software distribution, the first portion of the application software is recorded in an optical disc. Hence, the consumer is able to install the first portion of the application software in the host 11 of the computer terminal 1 through the optical disc drive 112. Moreover, the first portion of the application software further includes a driver program for the electronic key 2 so as to control communication between the electronic key 2 and the computer terminal 1.

The main purpose of the electronic key 2 is to enable execution of the application software by the computer terminal 1 only while the particular electronic key 2 is connected to the computer terminal 1. The electronic key 2 includes a processor 21 to control operations of the electronic key 2, a memory unit 22 coupled to the processor 21 for storing programs and data, and a data transmission interface 23 coupled to the processor 21 for controlling communication between the electronic key 2 and the computer terminal 1 in a known manner. In this embodiment, the data transmission interface 23 is a USB-compliant interface. The memory unit 22 includes a permanent data storage area and a temporary data storage area. When the second portion of the application software is downloaded by the computer terminal 1 from the remote server 3 after a successful registration procedure (to be described in greater detail hereinafter), the second portion of the application software is stored in the memory unit 22. A complete workable version of the application software thus resides in the host 11 and the electronic key 2 when the application software is successfully registered in the remote server 3.

In this embodiment, the size of the second portion of the application software may be reduced by having a third portion of the application software reside initially in the electronic key 2, thereby reducing the time spent by the user when conducting the registration/software download procedure. Moreover, since the electronic key 2 is an intelligent data storage medium, it can be used to execute some functions of the application and registration software. To this end, the following can be found in the memory unit 22 after a successful registration procedure for the application software: software library (i.e., the second and/or third portion of the application software); a software serial code associated with the application software; a key serial code associated with the electronic key 2; a disk serial number associated with the hard disk of the host 11; basic information of the software vendor; basic information of the application software; a software registration code; Basic Input/Output System (BIOS); an operating system of the electronic key 2; a verification program and data area; a driver program of the electronic key 2; etc. It should be noted herein that some of the aforesaid data, such as the software serial code, the key serial code, the Basic Input/Output System (BIOS), the operating system of the electronic key 2, etc., are required to be resident in the electronic key 2 prior to delivery to consumers in order to ensure basic operation of the electronic key 2.

As mentioned hereinabove, the remote server 3 is managed by the software vendor, and can be accessed by the computer terminal 1 through a network. The remote server 3 includes a software management program, the second portion of the application software, and a database containing software serial codes and key serial codes. When the computer terminal 1 conducts the registration procedure with the remote server 3, the remote server 3 will receive the following user information from the computer terminal 1 for identifying the user: the software serial code of the application software installed in the computer terminal 1; and the key serial code of the electronic key 2 that is connected to the computer terminal 1. Moreover, in order to further enhance software management, in this embodiment, the user information received by the remote server 3 additionally includes the hard disk serial number of the computer terminal 1, thereby preventing installation of the same application software product in different computer terminals 1.

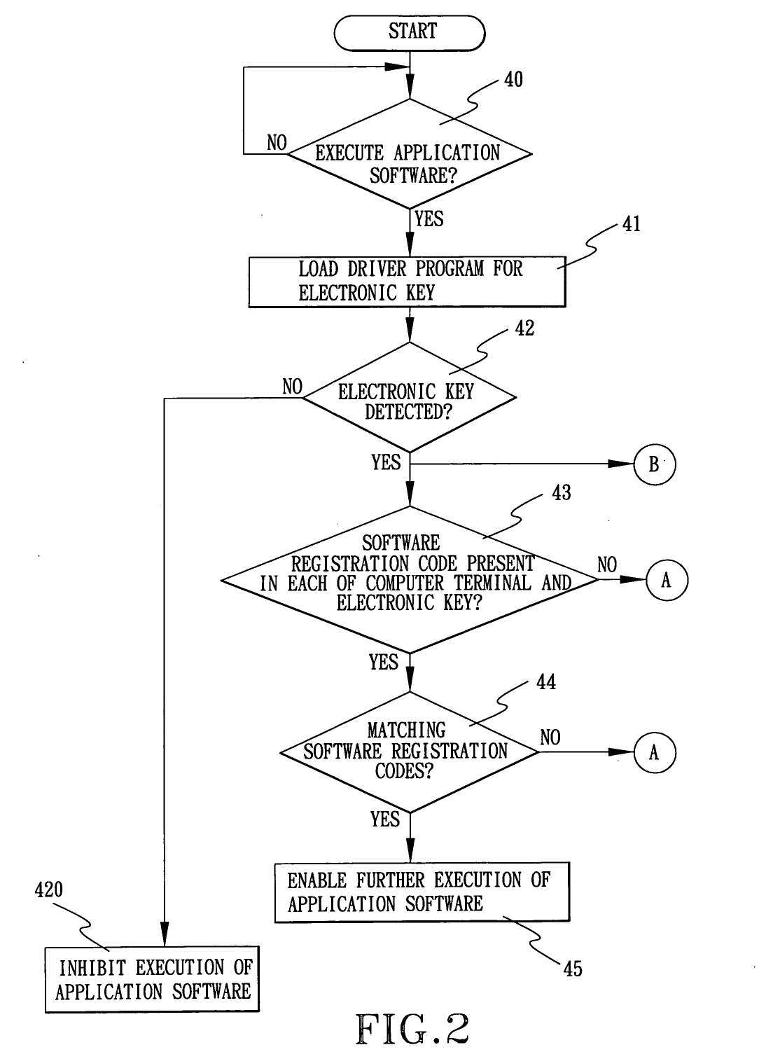

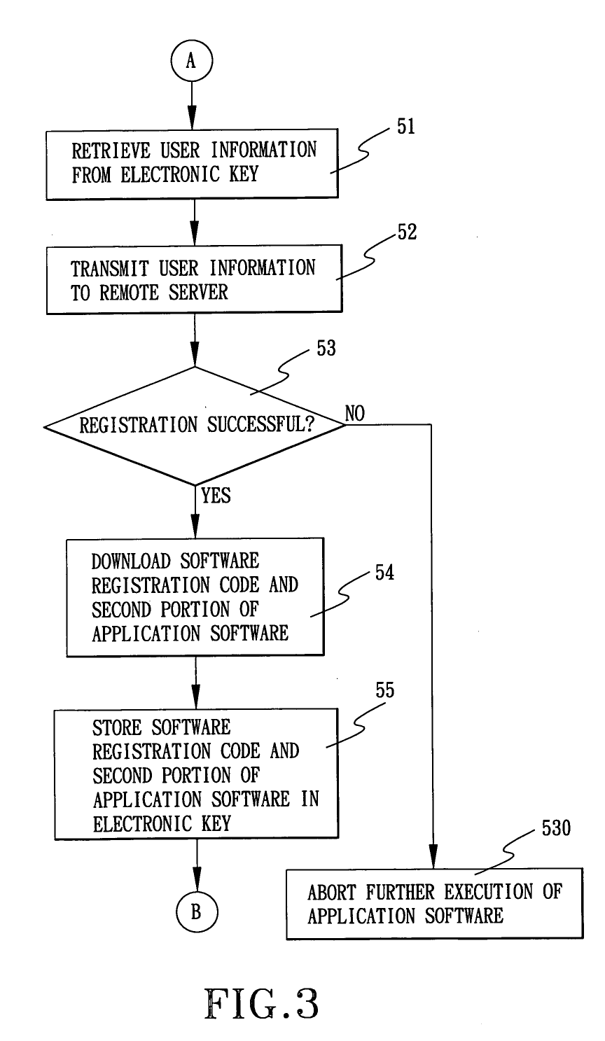

The preferred embodiment of the computer-implemented method for controlling execution of application software by the computer terminal 1 according to this invention will now be described in greater detail with reference to FIGS. 2 and 3. In the following description, it is assumed that the first portion of the application software and the driver program for the electronic key 2 are already installed in the hard disk of the host 11 of the computer terminal 1, such as through the optical disk drive 112.

In step 40 of FIG. 2, the computer terminal 1 determines whether it is intended to execute the application software.

In step 41, upon determining that the application software is to be executed, the driver program for the electronic key 2 is loaded into the computer terminal 1.

Then, in step 42, the computer terminal 1 will detect whether the electronic key 2 is connected thereto, i.e., whether the data transmission interface 23 of the electronic key 2 is connected to the transmission interface of the computer terminal 1. In the affirmative, the flow goes to step 43. Otherwise, the flow goes to step 420, where execution of the application software is inhibited. Accordingly, execution of the application software is possible only when the electronic key 2 is connected to the computer terminal 1.

In step 43, the registration software enables the computer terminal 1 to verify presence of a software registration code in each of the computer terminal 1 and the electronic key 2. In the affirmative, the flow goes to step 44. Otherwise, the flow goes to step 51 in FIG. 3.

In step 44, the computer terminal 1 verifies whether the software registration code stored therein matches that stored in the electronic key 2. In the negative, the flow goes to step 51 in FIG. 3. Otherwise, the flow goes to step 45, where further execution of the application software by the computer terminal 1 is enabled.

In step 51 of FIG. 3, the computer terminal 1 will retrieve the user information, such as the software serial code associated with the application software and the key serial code associated with the electronic key 2, from the electronic key 2.

In step 52, the computer terminal 1 establishes a network connection with the remote server 3, and initiates a registration procedure with the remote server 3 by transmitting the user information retrieved from the electronic key 2, together with the disk serial number (obtained using the Operating System of the host 11) associated with the hard disk of the computer terminal 1, to the remote server 3 via the network connection.

In step 53, the remote server 3 determines whether the registration procedure with the computer terminal 1 is a success. Particularly, the remote server 3 will check for consistency of the information received from the computer terminal 1 with that established in its database. If the registration procedure is a success, the flow goes to step 54. Otherwise, the flow goes to step 530, where the computer terminal 1 is caused to abort further execution of the application software.

In step 54, the remote server 3 will form a software registration code based on a server-generated registration serial number, basic information of the software vendor, basic information of the application software, and the software serial code, the key serial code and the disk serial number received from the computer terminal 1. A copy of the software registration code is stored in the database of the remote server 3. Thereafter, the remote server 3 enables the computer terminal 1 to download the software registration code and the second portion of the application software therefrom.

Subsequently, in step 55, the computer terminal 1 stores the software registration code, and transmits the software registration code and the second portion of the application software to the electronic key 2 for storage in the latter. The flow then goes back to step 43 of FIG. 2.

Preferably, the computer terminal 1 stores the software registration code thereof in a location which is outside a pre-configured formatted partition of the hard disk, and which is inaccessible using the operating system of the computer terminal 1. Therefore, the software registration code in the computer terminal 1 will not be altered even if the hard disk is reformatted.

It is noted that a copy of the software registration code is stored in the database of the remote server 3 in step 54. As such, the remote server 3 is able to check for consistency of user information with that in the database as described in step 53. An example of inconsistent user information includes the same set of software and key serial codes but different disk serial numbers. By checking the existence of inconsistent user information, the remote server 3 can determine whether the application software is being pirated. For example, different registration procedures involving the same set of software and key serial codes but with different disk serial numbers, or different software and key serial codes but with the same disk serial number, imply the existence of software piracy.

Preferably, in step 45, while the computer terminal 1 executes the application software, the registration software of the present invention additionally comprises program instructions for aborting further execution of the application software by the computer terminal 1 upon detection by the computer terminal 1 that the electronic key 2 was disconnected therefrom.

Preferably, the registration software of the present invention further comprises program instructions for enabling the computer terminal 1 and the electronic key 2 to perform a verification procedure while the computer terminal 1 executes the application software so as to prevent infringers from bypassing the aforementioned code checking mechanism. In the verification procedure, the electronic key 2 randomly generates verification codes transmitted to and stored in the computer terminal 1 in an encrypted and compressed format for security purposes. When a verification period (such as 10 to 49 minutes) corresponding to a current verification code and set by the electronic key 2 has expired, the electronic key 2 compares the verification code stored in the computer terminal 1 with that generated thereby. Further execution of the application software is enabled, and another verification code with a corresponding verification period is generated when a match is detected. Otherwise, the flow goes to step 51 in FIG. 3 to proceed with the server registration procedure.

In addition, when the computer terminal 1 intends to execute the second portion of the application software in the electronic key 2, data to be processed using the second portion of the application software is sent by the computer terminal 1 to the electronic key 2, and calculations associated with the second portion of the application software are performed by the processor 21 of the electronic key 2 using the data from the computer terminal 1 in the preferred embodiment. The results of the calculations performed by the electronic key 2 are then sent to the computer terminal 1 in an encrypted and compressed format. Therefore, since calculations associated with the second portion of the application software are performed by the electronic key 2 (which is relatively difficult to replicate), there is no need to send the program instructions for performing such calculations to the computer terminal 1. Software anti-piracy is further enhanced accordingly.

It has thus been shown that, before application software can be executed by a computer terminal 1, the computer terminal 1 is connected to an electronic key 2 and initiates a registration procedure with a remote server 3 so as to obtain a software registration code that is stored in each of the computer terminal 1 and the electronic key 2. Thereafter, it is only when the computer terminal 1 is connected to the registered electronic key 2 and when the software registration code stored in the computer terminal 1 matches that stored in the electronic key 2 will subsequent execution of the application software by the computer terminal 1 be enabled. Because execution of the application software requires the registered electronic key 2, which is relatively difficult to replicate, and the matching software registration codes obtained from a successful registration procedure with the remote server 3 that is managed by the software vendor, use of pirated software can be inhibited and monitored by software vendors to discourage software piracy.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A computer-implemented method for controlling execution of application software by a computer terminal, at least a first portion of the application software being loaded into a data storage medium of the computer terminal, said method comprising:
a) when it is intended to execute the application software, enabling the computer terminal to detect presence of an electronic key that is connected thereto;
b) inhibiting execution of the application software upon detection by the computer terminal that the electronic key is disconnected therefrom;
c) upon detection by the computer terminal that the electronic key is connected thereto, enabling the computer terminal to verify presence of a software registration code in each of the computer terminal and the electronic key;
d) upon detection by the computer terminal that at least one of the computer terminal and the electronic key does not have a software registration code stored therein, enabling the computer terminal to initiate a registration procedure with a remote server so as to obtain the software registration code therefrom and so as to store the software registration code obtained from the remote server in each of the computer terminal and the electronic key;
e) upon detection by the computer terminal that each of the computer terminal and the electronic key has a software registration code stored therein, enabling the computer terminal to verify if the software registration code stored in the computer terminal matches that stored in the electronic key;
f) enabling further execution of the application software by the computer terminal upon detection thereby that the software registration code stored in the computer terminal matches that stored in the electronic key; and
g) aborting further execution of the application software by the computer terminal upon detection thereby that the software registration code stored in the computer terminal does not match that stored in the electronic key.

2. The computer-implemented method as claimed in claim 1, the data storage medium of the computer terminal that has the first portion of the application software loaded therein being a hard disk, wherein said step d) includes the sub-step of:
enabling the computer terminal to transmit user information to the remote server, the user information including at least one of a software serial code associated with the application software, a key serial code associated with the electronic key, and a disk serial number associated with the hard disk.

3. The computer-implemented method as claimed in claim 1, a second portion of the application software being resident in the remote server, wherein said step d) includes:
enabling the computer terminal to download the second portion of the application software from the remote server and to store the second portion of the application software in the electronic key when the software registration code is obtained from the remote server.

4. The computer-implemented method as claimed in claim 1, wherein, in step f), further execution of the application software is aborted by the computer terminal upon detection by the computer terminal that the electronic key was disconnected therefrom.

5. The computer-implemented method as claimed in claim 1, wherein said step g) includes:
enabling the computer terminal to initiate the registration procedure with the remote server upon detection by the computer terminal that the software registration code stored in the computer terminal does not match that stored in the electronic key; and
aborting further execution of the application software by the computer terminal when the registration procedure is unsuccessful.

6. The computer-implemented method as claimed in claim 1, wherein said step f) includes:
enabling the electronic key to generate a random verification code transmitted to and stored in the computer terminal in an encrypted and compressed format;
upon detection by the electronic key that a verification period corresponding to the verification code and set by the electronic key has expired, enabling the electronic key to compare the verification code stored in the computer terminal with that generated thereby;
upon detection by the electronic key of a match between the verification code stored in the computer terminal and that generated thereby, enabling further execution of the application software by the computer terminal, and enabling the electronic key to generate another verification code with a corresponding verification period; and
upon detection by the electronic key that the verification code stored in the computer terminal does not match that generated thereby, enabling the computer terminal to initiate the registration procedure with the remote server.

7. The computer-implemented method as claimed in claim 6, wherein the random verification code is transmitted to and stored in the computer terminal in an encrypted and compressed format.

8. The computer-implemented method as claimed in claim 3, wherein said step f) includes, when the computer terminal intends to execute the second portion of the application software in the electronic key,
enabling the computer terminal to send data to be processed using the second portion of the application software to the electronic key,
enabling the electronic key to perform calculations associated with the second portion of the application software using the data from the computer terminal, and
enabling the electronic key to send results of the calculations performed thereby to the computer terminal.

9. The computer-implemented method as claimed in claim 8, wherein the results of the calculations performed by the electronic key are sent to the computer terminal in an encrypted and compressed format.

10. A computer program product comprising program instructions for causing a computer terminal to perform steps of the computer-implemented method according to claim 1.

11. A software registration method, comprising:
a) providing a computer readable storage medium and an electronic key, the computer readable storage medium comprising program instructions of at least a first portion of application software to be loaded into a data storage medium of a computer terminal, the electronic key being connectible to the computer terminal;
b) providing a remote server that permits the computer terminal loaded with the application software and connected to the electronic key to initiate a registration procedure therewith for storing user information in the remote server; and
c) enabling the remote server to issue a software registration code required by the computer terminal when executing the application software upon determination by the remote server that the registration procedure in step b) was successful.

12. The software registration method as claimed in claim 11, wherein the user information includes at least one of a software serial code associated with the application software, a key serial code associated with the electronic key, and a disk serial number associated with the data storage medium of the computer terminal.

13. The software registration method as claimed in claim 11, wherein a second portion of the application software is resident in the remote server, said step c) further including:
enabling the computer terminal to download the second portion of the application software from the remote server for storage in the electronic key.
